(19) United States
(12) Patent Application Publication
(10) Pub. No.: US 2009/0194228 A1
(43) Pub. Date: Aug. 6, 2009

(54) Multilaminate Bamboo

(76) Inventor: Tom Sullivan, San Marcos, CA (US)

Correspondence Address: ERIC HANSCOM, 7395 PORTAGE WAY, CARLSBAD, CA, 92011, US

(21) Appl. No.: 12/418,715

(22) Filed: Apr. 6, 2009

Related U.S. Application Data
(62) Division of application No. 11/751,542, filed on May 21, 2007.
(60) Provisional application No. 60/802,224, filed on May 19, 2006.

(51) Int. Cl. B32B 38/04; B32B 37/12

(52) U.S. Cl. 156/250; 156/60

(57) ABSTRACT

A bamboo laminate is provided having a bamboo core panel and a bamboo sheet. The bamboo laminate has a sheet length and a sheet width. The bamboo core panel has a top surface and a bottom surface. The bamboo core panel has a core vertical-grain layer with grain extending substantially parallel to the sheet width and substantially perpendicular to the sheet length. The bamboo sheet is attached to the top surface of the bamboo core panel.

### CROSS REFERENCE TO RELATED APPLICATIONS

This patent application is a divisional application of U.S. patent application Ser. No. 11/751,542 filed on May 21, 2007, which in turn is a nonprovisional of U.S. Patent Application Ser. No. 60/802,224 filed on May 19, 2006, the entireties of which are hereby incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

Although bamboo is frequently referred to as a tree, it is actually a grass. Bamboo lacks a vascular cambium layer and meristem cells at the top of the culm (stem). Meristem cells in a tree make it grow taller, and the vascular cambium is the portion of the tree that grows beneath its bark. Unlike a tree, a bamboo stem will typically reach its full height in one growing season; however, when bamboo is harvested for wood, stems older than one year and less than five years old are usually selected because first-year stems are not fully woody and thus are not as strong.

The structural strength and hardness of bamboo stems is due to masses of heavily lignified tracheids and fibers associated with the vascular bundles. The wood (xylem) of conifers and dicot trees is composed of concentric layers of dense, lignified cells containing cellulose and lignin in their secondary walls. In addition to cellulose and lignin, the thick-walled fibers of bamboo also contain up to five percent silica in the form of silicon dioxide (Si02). Although bamboo culms do not have the structure of true wood, they are very hard because they contain silica and lignin.

There are three types of bamboo grain: vertical-grain, flat-grain, and -end grain. Vertical-grain, approximately ¼″ wide, is taken from the side of the split pole; flat-grain, approximately ⅝″ wide, is from the face of the pole; and end-grain is the cross section of the pole. End-grain is the pattern observed in a piece of bamboo when it is viewed from a surface displaying the ends of the bamboo's fiber. Vertical-grain, also known as long-grain or side-grain, is the pattern observed in a piece of bamboo when it is viewed from a surface displaying the sides of the bamboo's fiber. Direction is commonly associated with long-grain patterns, and the grain is said to run in the direction of the bamboo's fiber. For a stalk of bamboo, end-grain is visible on the ends of the stalk, and long-grain runs along the length of the stalk and is visible on the side surfaces of the stalk. The grain on the face of the bamboo pole is known as the face-grain or the flat-grain. The vertical-grain is the portion of a stalk corresponding to the thickness, or the narrower dimension of the stalk. End-grain sheet is the term normally used to describe laminates where the surface of a laminate sheet displays mainly the fiber ends. Long-grain sheet is used where the surface of a laminate displays mainly the fiber sides. Similarly, the long-grain is said to run in the direction that the fiber mainly points, in aggregate, over the laminate sheet under consideration.

Thus, when laminated, the flat-grain orientation is the lamination of slats of bamboo, normally about ⅝″ wide and ¼″ thick, cut along the vertical axis of the bamboo trunk. The flat-grain orientation displays large areas of the distinctive knuckles most often associated with bamboo. The vertical-grain orientation is the lamination of flat-grain slats turned on end such that each of the laminated vertical-grain slats are about ¼″ wide and ⅝″ thick. The vertical orientation shows narrower bands of bamboo grain and less prominent bamboo knuckles. Vertical-grain orientation is a much harder surface than flat grain orientation and thus is a good orientation for cutting boards. The end-grain orientation is the lamination of many small pieces of bamboo cut perpendicular to the grain direction. The end-grain orientation highlights the internal fibers of the bamboo and is a harder surface than the vertical-grain orientation. The end-grain orientation does not show knuckles.

Because bamboo stems are typically only 1 mm to 30 cm in diameter, they cannot be directly used to make boards or plywoods. In the past, laminated bamboo boards and sheets have been constructed using bamboo strips and adhesives. However, these boards and sheets typically do not have exposed end-grain portions on the upper and or lower surfaces. Because bamboo is typically stronger (more resistant to compressive forces) along its axis, it would be desirable to make bamboo plywood and similar composites having end grain material at the exterior thereof. End grain is also visually interesting.

### SUMMARY OF THE INVENTION

A bamboo laminate is provided having a bamboo core panel and a top bamboo sheet. The bamboo laminate has a sheet length and a sheet width. The bamboo core panel has a top surface and a bottom surface. The bamboo core panel has a core vertical-grain layer with grain extending substantially parallel to the sheet width and substantially perpendicular to the sheet length. The top bamboo sheet is attached to the top surface of the bamboo core panel.

According to an exemplary embodiment of the present invention, the top bamboo sheet is selected from the group consisting of an end-grain layer with grain extending substantially perpendicular to the sheet width and the sheet length, at least one flat-grain layer with grain extending substantially parallel to the sheet length, and at least one vertical-grain layer with grain extending substantially parallel to the sheet length.

According to an exemplary embodiment of the present invention, the bamboo core panel is a three-ply core panel having a first flat-grain layer attached to a top of the core vertical-grain layer and a second flat-grain layer attached to a bottom of the core vertical-grain layer, the first flat-grain layer and the second flat-grain layer having grain extending substantially parallel to the sheet length.

According to an exemplary embodiment of the present invention, the bamboo laminate further includes a bottom bamboo sheet attached to the bottom surface of the bamboo core panel.

According to an exemplary embodiment of the present invention, the bottom bamboo sheet is selected from the group consisting of an end-grain layer with grain extending substantially perpendicular to the sheet width and the sheet length, at least one flat-grain layer with grain extending substantially parallel to the sheet length, and at least one vertical-grain layer with grain extending substantially parallel to the sheet length.

According to an exemplary embodiment of the present invention, the bamboo laminate is glued together with a non-formaldehyde adhesive.

According to an exemplary embodiment of the present invention, the bamboo laminate forms a counter top or a cutting board.

A bamboo laminate is provided having an in-line end-grain bamboo layer. The in-line end-grain bamboo layer includes a plurality of rectangular bamboo end-grain slabs glued together. Each of the plurality of rectangular bamboo end-grain slabs have two slab width sides and two slab length sides. The slab length sides are greater in length than the slab width sides. Each of the plurality of rectangular bamboo end-grain slabs are glued together such that within the in-line end-grain bamboo layer the slab length sides are adjacent to other slab length sides and the slab width sides are adjacent to other slab width sides.

A bamboo laminate is provided having a parquet end-grain bamboo layer. The parquet end-grain bamboo layer includes a plurality of end-grain bamboo subsections. The plurality of end-grain bamboo subsections each including a plurality of rectangular bamboo end-grain slabs glued together along lengths of the plurality of rectangular bamboo end-grain slabs. The plurality of end-grain bamboo subsections being glued together such that the plurality of end-grain bamboo subsections are alternately oriented with the lengths of the plurality of rectangular bamboo end-grain slabs extending alternately widthwise and lengthwise along a top surface of the parquet end-grain bamboo layer.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE DRAWINGS

FIG. 1 is a simplified drawing of a solid bamboo end-grain sheet.

FIG. 2 is a simplified drawing of a solid bamboo end-grain sheet with non-random shading.

FIG. 3 is a cross-section of a bamboo laminate according to one embodiment of the invention.

FIG. 4 is a simplified drawing of a bamboo end-grain sheet according to one embodiment of the invention.

FIG. 5 is a simplified drawing of an unsupported bamboo end-grain sheet according to one embodiment of the invention.

FIG. 6 is a cross-section of a bamboo laminate according to one embodiment of the invention.

FIG. 7 is a cross-section of a bamboo laminate according to one embodiment of the invention.

FIG. 8 is a simplified drawing depicting the fabrication of a portion of a bamboo laminate according to one embodiment of the invention.

FIG. 9 is a drawing of a portion of a bamboo laminate according to one embodiment of the invention.

FIG. 10 is a simplified drawing depicting the fabrication of the bamboo end-grain sheets according to one embodiment of the invention.

FIG. 11 is a partially exploded view of a bamboo laminate according to one embodiment of the invention.

FIG. 12 is an exemplary counter top constructed with a bamboo laminate according to one embodiment of the invention.

FIG. 13 is a partially exploded view of a bamboo laminate according to another embodiment of the invention.

FIG. 14 is a partially exploded view of a bamboo laminate according to yet another embodiment of the invention.

### DETAILED DESCRIPTION

Many aspects of the invention can be better understood with references made to the drawings below. The components in the drawings are not necessarily drawn to scale. Instead, emphasis is placed upon clearly illustrating the components of the present invention.

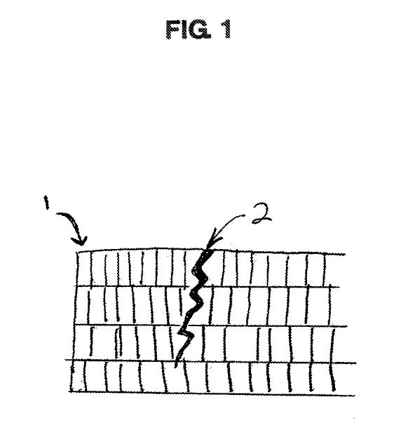

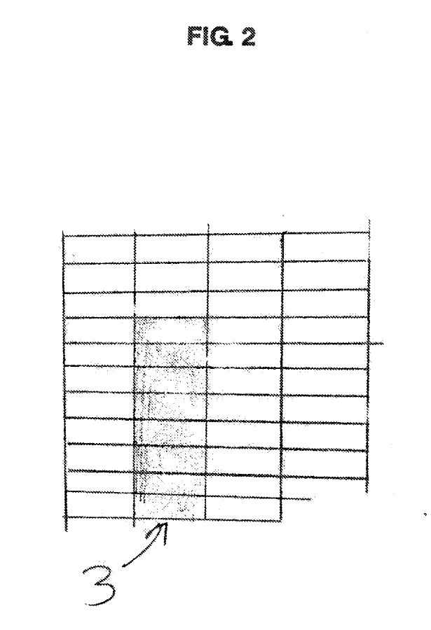

When a solid in-line end-grain sheet of bamboo 1 is glued up to a typical 30 inch by 96 inch size, the end-grain is very fragile and brittle, making it susceptible to cracking. In one embodiment, cracking occurred in approximately 20% of the sheets constructed. Typically, as shown in FIG. 1, a crack 2 would begin at the edge and run inwardly about 3 inches or more. This is likely due to the natural tendency of bamboo to swell and shrink in one direction, expanding primarily in thickness. Further, larger panels tend to warp severely, even when anchored with brackets at 10″ increments. Additionally, as shown in FIG. 2, the color of the raw materials varies from very dark to very light and, when glued together in one direction, the end-grain color variations 3 are very obvious.

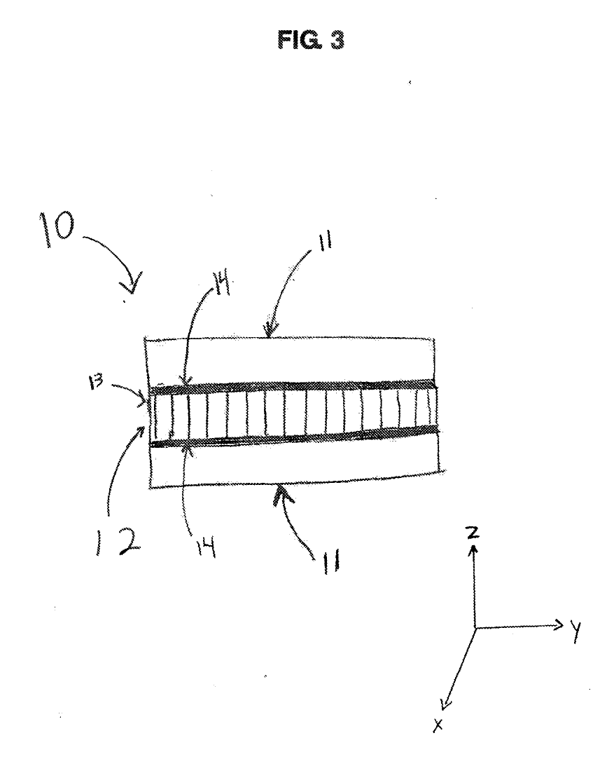

In one embodiment, as shown in FIG. 3, the invention solves the cracking problems above by providing a bamboo multilaminate 10 constructed by gluing a flat-grain, vertical-grain, or end-grain sheet 11 to each side of a three-ply bamboo core panel 12. The three-ply bamboo core panel 12 is constructed of a vertical-grain center core 13 sandwiched between two thinner flat-grain bamboo sheets 14. The grain direction of each layer of the bamboo core panel 12 is different from its adjacent layer(s). In a three dimensional Cartesian coordinate system, with x pointing toward the observer and z pointing up, the center core 13 grain direction is along the x-axis (ie., sheet width), the thinner bamboo sheet 14 grain direction is along the y-axis (Le., sheet length), and the sheet 11 grain direction is along the y-axis for flat-grain and vertical-grain sheets and along the z-axis (i.e., sheet thickness) for end-grain sheets. A multi-ply bamboo panel may also be used, in which there are two or more layers of bamboo in the bamboo core panel.

Thus, as depicted in FIG. 3, a multilaminate bamboo sheet 10 includes a bamboo core panel 12 and vertical-grain, flat-grain, or end-grain sheets 11 attached to a top and bottom side of the bamboo core panel 12. The bamboo core panel 12 includes a vertical-grain center core 13 having grain extending along a width of the sheet and flat-grain sheets 14 having grain extending along a length of the sheet. The flat-grain sheets 14 are attached to a top end and a bottom end of the vertical-grain center core 13 such that the flat-grain sheets 14 have a grain perpendicular to the grain of the vertical-grain center core 13. In one exemplary embodiment, an end-grain sheet 11 is attached to a top end and a bottom end of the flat-grain sheets 14. In an alternative embodiment, either flat-grain or vertical-grain sheets 11 are attached to the flat-grain sheets 14 such that the grain is parallel to the grain of the flat-grain sheets 14.

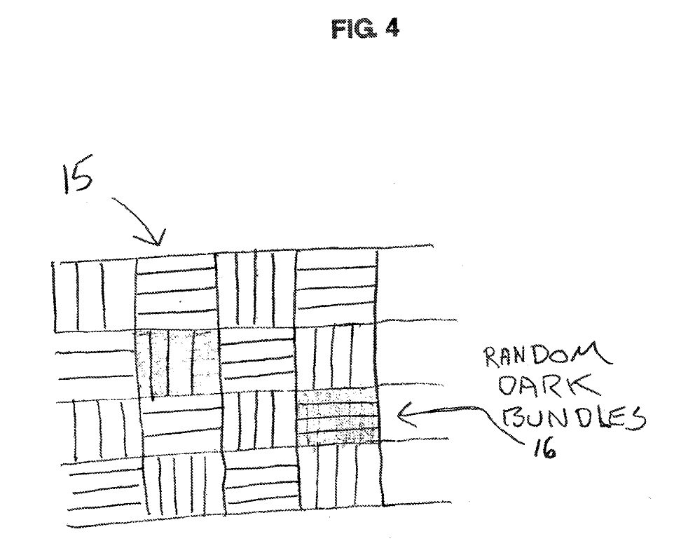

According to one embodiment, as shown in FIG. 4, the bamboo end-grain sheet 15 comprises alternating bundles of end-grain, where the bundles are arranged in an alternating orientation, similar to a typical parquet floor pattern, before they are glued together. In an exemplary embodiment, the parquet end-grain sheet is 1.5″ to 2″ thick, which is a standard counter thickness. In another exemplary embodiment in which the parquet end-grain sheet is attached to a bamboo core panel, the thickness of the end-grain sheet is about 8 mm to about 10 mm. The end-grain sheet is thicker than the typical veneer, which is usually less than 3 mm thick. In another embodiment, the thickness of the end-grain sheet is in the range of greater than 3 mm to about 10 mm. In a further embodiment, the thickness of the end-grain sheet is in the range of about 4 mm to about 8 mm. The end-grain sheet may be as thick as about 25.4 mm if desired. The grain direction is out of the page toward the observer. In an exemplary embodiment, the size of each bundle of fibers is about 19 mm by about 19 mm. The parquet pattern is important because the fibers in a bundle are captive and cannot expand due to the adjacent bundles on all four sides compressing against it as the neighboring bundles expand. Thus, the swelling or expansion of individual bundles retards the swelling or expansion of the entire sheet of bundles. Additionally, in an embodiment, by alternating bundles based on end-grain, it is possible to have different bundle colors 16 randomly scattered throughout the sheet 15, which is considered a desirable feature by many consumers.

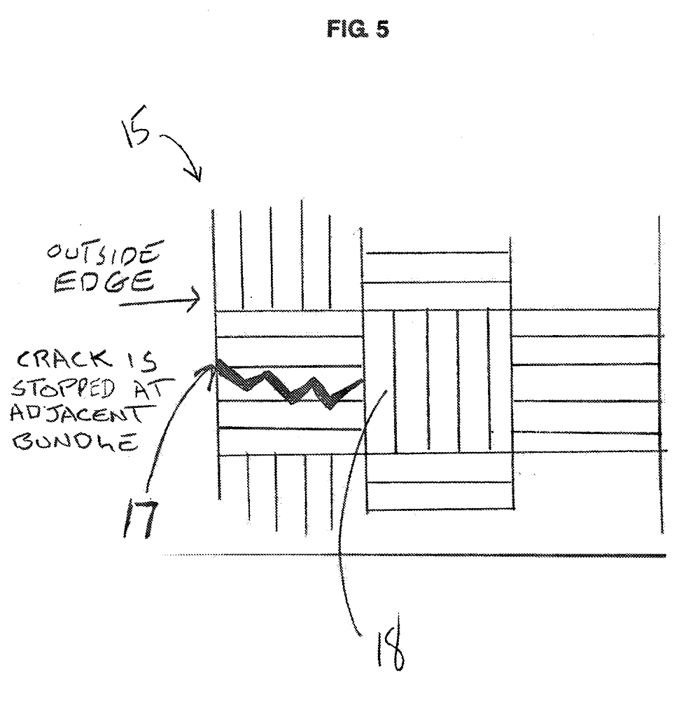

As shown in FIG. 5, the bundles on the peripheral or outside edges of the bamboo endgrain sheet 15 are only held captive on three sides, allowing cracks 17 to develop in an outside bundle. The grain direction is out of the page toward the observer. However, the crack 17 is usually stopped by the opposing fiber direction in an adjacent bundle 18. Although the amount of cracking has been reduced, warping may still occur.

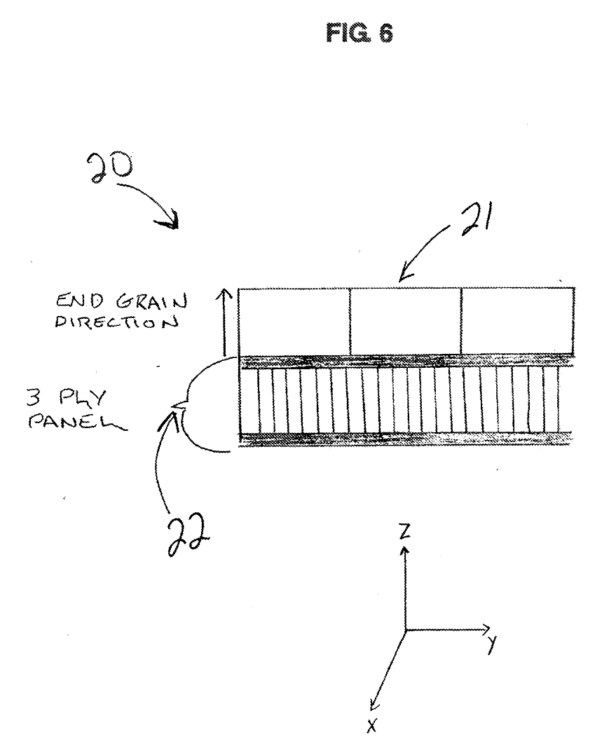

In another embodiment, as shown in FIG. 6, to reduce warping, a bamboo multilaminate 20 is constructed wherein a bamboo end-grain sheet 21 is glued to a three-ply panel bamboo panel 22. In FIG. 6, the end-grain 21 direction is along the z-axis, the shaded portions of the three-ply panel have a grain direction along the y-axis, and the center portion of the three-ply panel has a grain direction along the x-axis. In addition to reducing the warping, this reduces the amount of splitting of the outer most bundles. In one exemplary embodiment, the end-grain sheet 21 is about 19 mm thick and the three-ply panel 22 is about 19 mm thick.

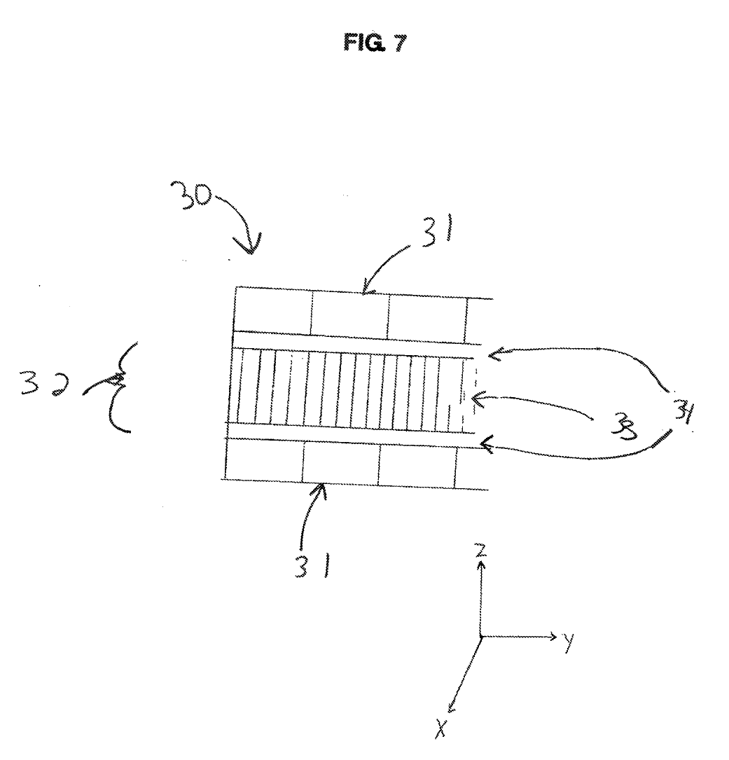

In another embodiment, as shown in FIG. 7, to further reduce warping and splitting, the bamboo multilaminate 30 is constructed with end-grain sheets 31 applied to both sides of the three-ply panel bamboo panel 32. The grain directions are as described above with reference to FIG. 3. In one embodiment, the three-ply panel 32 reduces the cracking in the outermost end-grain bundles such that the rejection rate of a manufactured panel due to cracking is less than about 1%. In another embodiment, the end-grain panels 31 are about 8 mm to about 10 mm thick. In another embodiment, the middle ply 33 of the three-ply panel 32 is about 14 mm thick and the outer two plies 34 are each about 4 mm thick. The multi-ply panel may comprise more layers than the three described above, such as 4, 5, or 6 layers, but the most commonly one available is the three-ply configuration.

The adhesives typically used to manufacture bamboo laminates contain formaldehyde because of cost concerns and fast curing times, and these adhesives may be used in the construction of bamboo panels according to one embodiment of the invention. In another embodiment, the invention uses non-formaldehyde containing adhesives. Non-formaldehyde adhesives are typically more expensive than those containing formaldehyde, and have longer curing times. However, non-formaldehyde adhesives are preferred by some consumers over formaldehyde adhesives because the latter have more off-gassing, which may be toxic when used as a counter top or cutting board.

The following nonlimiting example illustrates an embodiment of the invention in more detail.

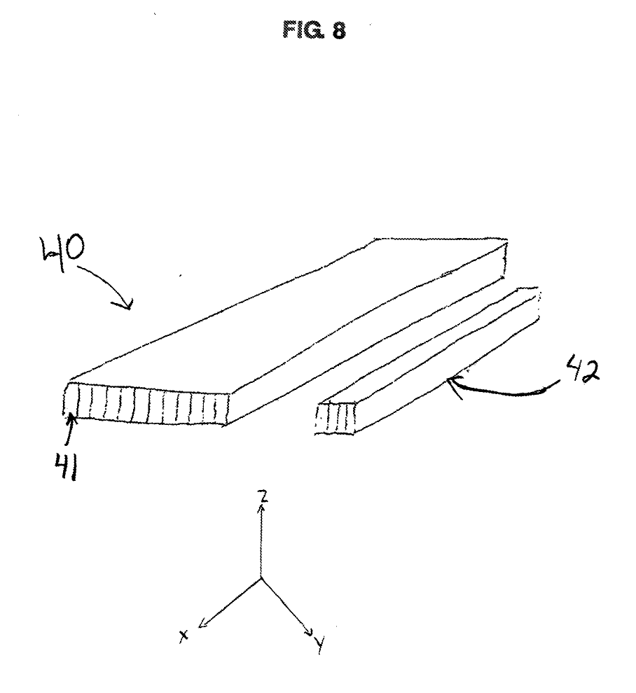

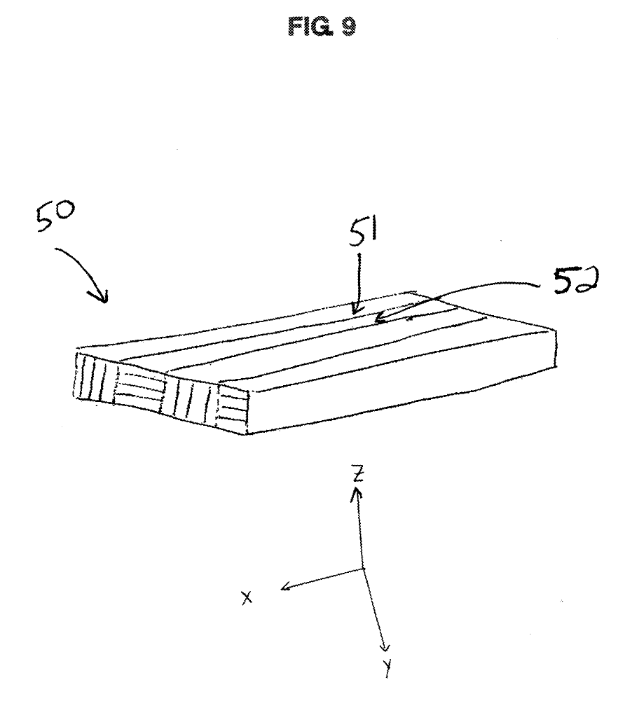

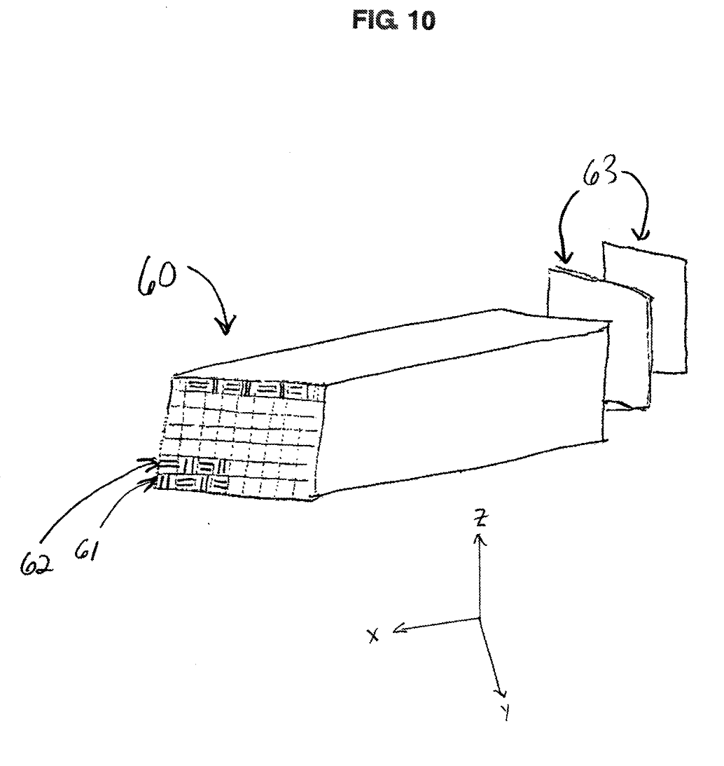

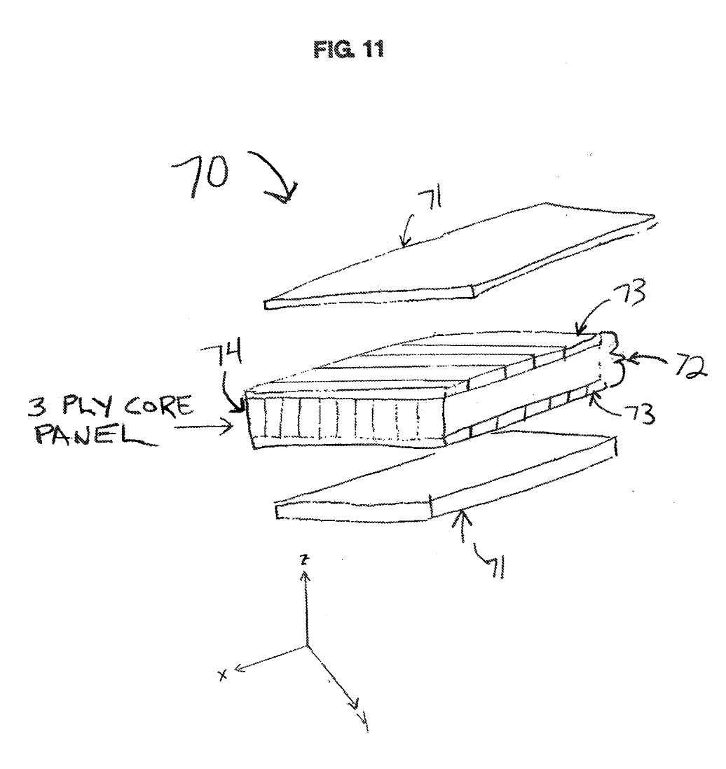

First, Moso Bamboo (Phyllostachys pubescens) that is about 4½ years old is split, planed, kiln dried, and then stabilized for two weeks in a room with similar temperature and humidity conditions as those of the assembly room. The vertical planks of bamboo 41 (obtained, e.g., by quarter-sawing or plain-sawing bamboo stalks) are glued using a four-way press with pressure applied on the top, bottom, and both long sides. The glue is an emulsion polymer isocyanate (EPI). non-formaldehyde, adhesive, available from Dynea Oy of Helsinki, Finland. As shown in FIG. 8, the cured plank 40 is sanded flat and smooth and then cut into lengthwise strips 42 having uniform lengths. In an exemplary embodiment, the cured plank 40 is cut into approximately 22 mm by 22 mm strips. The grain direction is along the x-axis (i.e., width of a sheet). The surface showing the face-grain is oriented in the x-z plane. As shown in FIG. 9, the strips 51, 52 are then oriented side by side in alternating directions, with a side-grain up orientation 51 being next to a face-grain up 52 orientation. The surface showing the face-grain of strip 51 is in the x-z plane, and the surface showing the face-grain of strip 52 is in the x-y plane. The strips are glued and pressed as above, and then sanded smooth and flat to form a sheet 50. As shown in FIG. 10, each sheet 61 is stacked on top of another sheet 62 and the sheets are glued together to form a beam 60, which according to an exemplary embodiment may be approximately 65 cm by 65 cm. The face-grain surface in each sheet layer 61 runs in a different direction relative to that of each adjacent sheet layer 62. Next, end-grain sheets 63 are sliced from the beam 60. In an exemplary embodiment, the end-grain sheets 63 are approximately 15 mm thick. As shown in FIG. 11, the multilaminate sheet 70 includes end-grain sheets 71 glued and pressed on to each side of the three-ply core panel 72. The three-ply core panel 72 may be constructed of a vertical-grain center core 74 and two flat-grain bamboo sheets 73. The center member 74 of the core panel 72 may be fabricated with approximately 12 mm thick bamboo planks glued together with the grain running in the direction of the x-axis (i.e., width of a laminated sheet). The center member 74 is then sandwiched with an adhesive between two bamboo sheets 73 that may be approximately 4 to 5 mm thick, each sheet having its grain running perpendicular to the center member 74 in the y-direction (i.e., length of a laminated sheet), thereby forming a three-ply laminate. After the three-ply core panel 72 is cured, it is sanded to a uniform thickness.

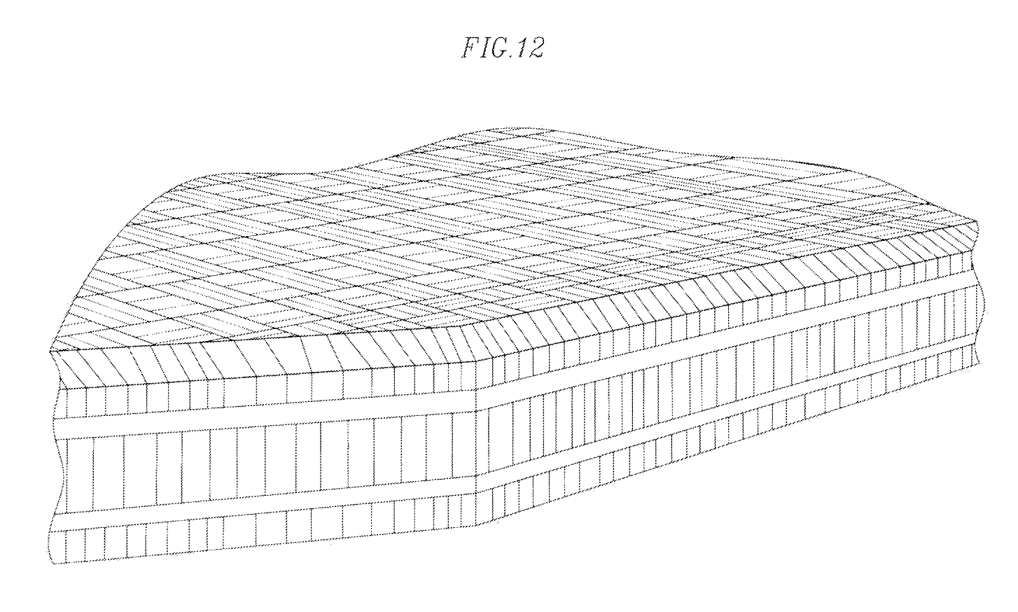

The bamboo multilaminate of Example 1 may be used to construct a cutting board or counter top with a stylish edge detail as shown in FIG. 12.

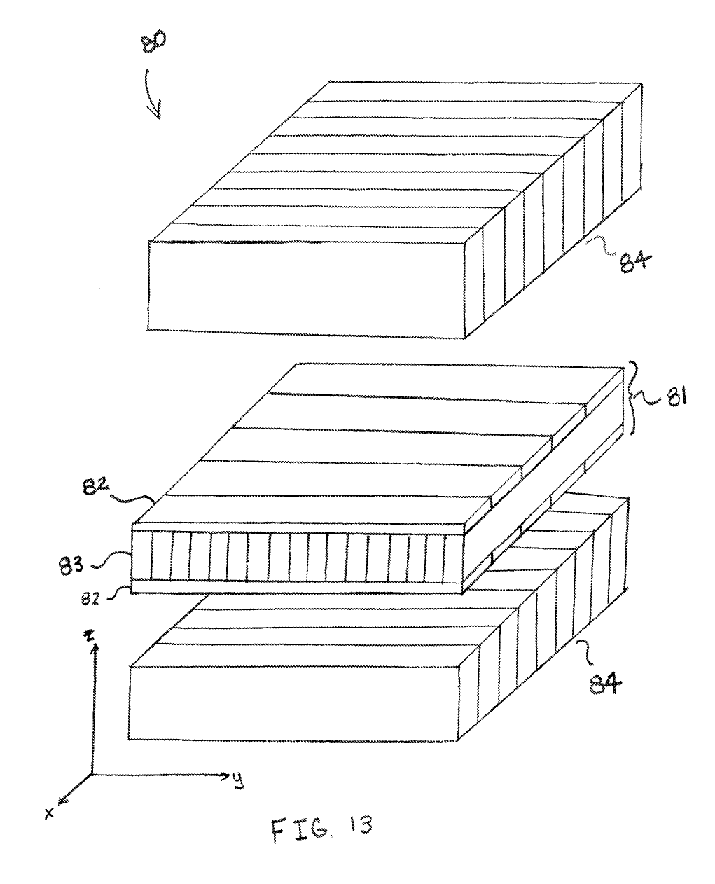

In an alternative embodiment as depicted in FIG. 13, the multilaminate sheet 80 includes vertical-grain sheets 84 glued and pressed on to each side of a three-ply core panel 81. The three-ply core panel 81 is constructed of a vertical-grain center core 83 with the grain oriented extending in the x-axis direction (i.e., sheet width) and two flat-grain bamboo sheets 82 with the grain oriented extending in the y-axis direction (i.e., sheet length). As discussed in relation to FIG. 11, the three-ply core panel 81 may be about 20 mm thick (z-axis direction), with the vertical-grain center core 83 being about 12 mm thick and the flat-grain sheets being about 4 mm to 5 mm thick. The vertical-grain sheets 84 may be around ⅝″ or 16 mm thick. Thus, as depicted in FIG. 12, the total thickness of the multilaminate sheet 80 may be about 52 mm or so, which is about 2″ thick. Of course, the thickness will vary with varying thickness of the components of the multilaminate sheet 80. Given a particular thickness of the three-ply core panel 81, to achieve a larger multilaminate sheet 80 thickness, an additional layers of vertical-grain sheets 84 may be glued and pressed on to adjacent vertical-grain sheets 84.

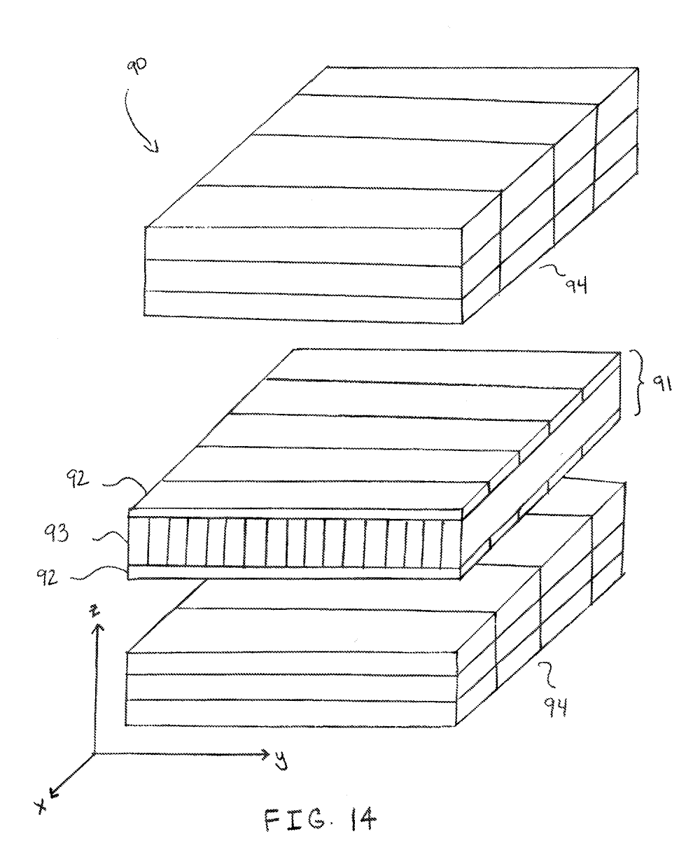

In another embodiment as depicted in FIG. 14, the multilaminate sheet 90 includes one or more flat-grain sheets 94 glued and pressed on to each side of a three-ply core panel 91. The three-ply core panel 91 is constructed of a vertical-grain center core 93 with the grain oriented extending in the x-axis direction (i.e., sheet width) and two flat-grain bamboo sheets 92 with the grain oriented extending in the y-axis direction (i.e., sheet length). As discussed in relation to FIG. 11, the three-ply core panel 91 may be about 20 mm thick (z-axis direction), with the vertical-grain center core 93 being about 12 mm thick and the flat-grain sheets being about 4 mm to 5 mm thick. The flat-grain sheets 94 may be around ¼″ or 6 mm thick. Thus, as depicted in FIG. 14, with three flat-grain sheet layers glued and pressed on to each side of the three-ply core panel 91, the total thickness of the multilaminate sheet 90 may be about 56 mm or so, which is a little more than about 2″ thick. Of course, the multilaminate sheet 90 thickness will vary with varying thickness of the components of the multilaminate sheet 90. Given a particular thickness of the three-ply core panel 91, to achieve a smaller multilaminate sheet 90 thickness, less flat-grain sheet layers 94 may be used.

Thicknesses of the components of the three-ply core panel may vary, thus the overall thickness of the three-ply core panel may also vary. In addition, the thickness of the flat-grain sheets and vertical-grain sheets may vary. Although ¼″ thick flat-grain sheets and ⅝″ thick vertical-grain sheets may typically be employed, flat-grain sheets and vertical-grain sheets that vary from these dimensions may be employed without departing from the scope of the invention. In order to achieve a particular multilaminate sheet thickness, the number of layers of flat-grain sheets (FIG. 14) or vertical-grain sheets (FIG. 13) may be adjusted to achieve a desired overall thickness, which maybe around 1.5″ or 2″.

Furthermore, the multi laminate bamboo may include in-line end-grain sheets or parquet end-grain sheets without the three-ply core panel. In such embodiments, the in-line end-grain sheets or parquet end-grain sheets may have a thickness of a standard counter depth, such as 1.5″ or 2″. Of course, the in-line end-grain sheets and parquet end-grain sheets utilized without the three-ply core panel may have greater or lesser thicknesses depending on its application.

While this invention has been described in connection with what are considered to be exemplary embodiments, it is to be understood that the invention is not limited to the disclosed embodiments, dimensions, and configurations but, on the contrary, also extends to various modifications and equivalent arrangements. The invention is limited only by the claims and their equivalents.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What I claim is:

1. A method of making a bamboo laminate having a sheet length and a sheet width, comprising:
forming a bamboo core panel having a top surface and a bottom surface and a core vertical-grain layer with grain extending substantially parallel to the sheet width and substantially perpendicular to the sheet length; and
attaching a top bamboo sheet to the top surface of the bamboo core panel.

2. The method of claim 1, wherein the top bamboo sheet is selected from the group consisting of an end-grain layer with grain extending substantially perpendicular to the sheet width and the sheet length, at least one flat grain layer with grain extending substantially parallel to the sheet length, and at least one vertical grain layer with grain extending substantially parallel to the sheet length.

3. The method of claim 2, wherein the top bamboo sheet is the end-grain layer and the end-grain layer is selected from the group consisting of an in-line end-grain layer and a parquet end-grain layer.

4. The method of claim 1, further comprising:
forming the bamboo core panel as a three-ply core panel having a first flat-grain layer attached to a top of the core vertical-grain layer and a second flat-grain layer attached to a bottom of the core vertical-grain layer, the first flat grain layer and the second flat-grain layer having grain extending substantially parallel to the sheet length.

5. The method of claim 1, further comprising:
attaching a bottom bamboo sheet to the bottom surface of the bamboo core panel.

6. The method of claim 5, wherein the bottom bamboo sheet is selected from the group consisting of an end-grain layer with grain extending substantially perpendicular to the sheet width and the sheet length, at least one flat-grain layer with grain extending substantially parallel to the sheet length, and at least one vertical-grain layer with grain extending substantially parallel to the sheet length.

7. The method of claim 1, further comprising:
gluing the bamboo core panel together and attaching the top bamboo sheet to the top surface of the bamboo core panel with a non-formaldehyde adhesive.

8. The method of claim 1, wherein the bamboo laminate forms a counter top or a cutting board.

9. A method of making a bamboo laminate comprising the steps of:
forming a bamboo core panel with a top surface and a bottom surface, where the bamboo core panel comprises a middle ply and two outer plies, where the middle ply is formed between the two outer plies, where the middle ply has a grain that is substantially perpendicular to grains of the two outer plies;
forming a top bamboo sheet; and
attaching the top bamboo sheet to the top surface of the bamboo core panel.

10. The method of claim 9, further comprising the steps of:
forming a bottom bamboo sheet; and
attaching the bottom bamboo sheet to the bottom surface of the bamboo core panel.

11. The method of claim 9, wherein the middle ply is a vertical-grain layer.

12. The method of claim 9, wherein the two outer plies are flat-grain sheets.

13. The method of claim 9, wherein the top bamboo sheet is a vertical grain sheet.

14. The method of claim 9, wherein the top bamboo sheet is a flat-grain sheet.

15. The method of claim 9, wherein the top bamboo sheet is an end-grain sheet.

16. The method of claim 9, where the top bamboo sheet is attached to the top surface of the bamboo core panel by gluing the two together using a non-formaldehyde glue.

17. A method of making a bamboo laminate comprising the steps of:
gluing together a plurality of vertical bamboo planks thereby creating a cured bamboo plank, where the grain of each vertical bamboo plank is aligned in the same direction;
cutting the cured bamboo plank lengthwise into strips having uniform lengths, where each strip has a face-grain direction;
gluing the strips together to form a cured bamboo sheet and gluing the cured bamboo sheets together to form a beam, where the face grain of adjacent strips in the beam are oriented in different directions;
cutting the beam into sheets thereby creating end-grain sheets;
forming a bamboo core panel with a top surface and a bottom surface, where the bamboo core panel comprises a middle ply and two outer plies, where the middle ply is formed between the two outer plies, where the middle ply is a vertical-grain layer, where the two outer plies are flat grain sheets, where the middle ply has a grain that is substantially perpendicular to grains of the two outer plies;
gluing an end grain sheet to the top surface of the bamboo core panel.

18. The method of claim 17, further comprising the step of:
gluing an end grain sheet to the bottom surface of the bamboo core panel.

19. The method of claim 17, wherein the face grain of adjacent strips in the beam are oriented in alternating, perpendicular directions.

20. The method of claim 17, where the gluing is performed using a non-formaldehyde glue.
